(19) United States
(12) Patent Application Publication
(10) Pub. No.: US 2006/0150241 A1
(43) Pub. Date: Jul. 6, 2006

(54) Method and system for public key authentication of a device in home network

(75) Inventors: Mi-suk Huh, Suwon-si (KR); Kyung-hee Lee, Yongin-si (KR); Bae-eum Jung, Seongnam-si (KR); Bum-jin Im, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/294,532

(22) Filed: Dec. 6, 2005

(30) Foreign Application Priority Data
Dec. 30, 2004 (KR) 2004-116270

(51) Int. Cl. H04L 9/32; H04L 9/00; G06K 9/00; G06F 17/30; G06F 15/16; G06F 7/04; G06F 7/58; G06K 19/00

(52) U.S. Cl. 726/4; 713/171

(57) ABSTRACT

A method and system for authenticating a home network device in a home network. According to the device authentication method, a public key list that includes an ID and public key information corresponding to the ID of home network devices is maintained. When an access of a joining device is received, it is requested to the joining device an ID and information relating to a public key of the joining device. The ID and the public key information are received from the joining device, and the public key list is updated by adding the received ID and public key information. The public key list before updating is transmitted to the joining device. The ID and the public key information of the joining device are transmitted to the home network devices. The joining device is a new device that joins a home network.

### CROSS-REFERENCE TO RELATED APPLICATIONS

This application claims priority from Korean Patent Application No. 2004-116270 filed on Dec. 30, 2004 in the Korean Intellectual Property Office, the entire disclosure of which is incorporated herein by reference.

### BACKGROUND OF THE INVENTION

1. Field of the Invention

Methods and systems consistent with the present invention relate generally to authenticating a device in a home network, and more particularly, to storing a public key list in a home network device, and verifying and authenticating public key information of a device using the stored public key list.

2. Description of the Related Art

Home network devices can be categorized into an information devices such as personal computers, facsimile machines, scanners, and printers; audio and video devices such as televisions, set-top boxes, digital versatile disk (DVD) players, video cassette recorders (VCRs), stereos, camcorders, and game consoles; control devices such as coffeemakers, electric rice pots, refrigerators, washers, microwave ovens, and cameras; and dummy devices such as remote controllers, interphones, sensors, and illuminators. The home network devices are connected to subnetworks such as telephone lines, wireless local area networks (WLANs) or Bluetooth networks, universal serial buses (USB), IEEE 1394 lines, and power lines depending on their categories.

Authentication in the home network can be achieved using a public key infrastructure (PKI) based on a Rivest Shamir Adelman (RSA) system.

The PKI is an integrated security system environment providing encryption and a digital signature through a public key algorithm. The PKI encrypts transmitted data and decrypts received data using a public key including an encryption key and a decryption key, and authenticates a user through the digital signature.

The encryption method utilizes a public key algorithm and a secret key algorithm. While the secret key algorithm utilizes a secret key shared by a sender and a recipient, the public key algorithm uses the asymmetric keys, encryption key and decryption key. In this point, these two algorithms require different key managements.

The PKI implements a system for creation, authentication, distribution, and secure management of the key for the sake of the common use of public key cryptography.

The PKI consists of a certificate authority that issues a certificate relating to the public key, a registration authority that verifies identity of a user in place of the certificate authority when the user requests the certificate; a directory that stores and retrieves the certificate, user information, a cross certificate, and a certificate revocation list (CRL); and a user who creates and authenticates the digital signature using the public key in various applications, and encrypts and decrypts data.

However, it is known that the public key system has a complicated procedure for the certificate registration of the public key at the certificate authority, and that the certificate registration is highly likely to be charged for. As for the chargeable public key, a considerable cost is incurred for issuing certificates to more than ten devices in the home network. In addition, since the public key system always needs to perform public key operations to verify the public key of the other party, a device with low resources has difficulty in verifying the device using the public key and always needs to check the CRL.

Alternatively, Universal Plug and Play (UPnP) can be adopted. UPnP is a Windows ME and Windows XP-based networking architecture allowing plug and play of network devices such as personal computers, personal digital assistants (PDAs), printers, broadband routers, and home appliances, in a home network. When a device is initially registered to a server with UPnP, however, user interventions are required and the public key is not shared with control points (CPs) while the device shares a public key with its CP.

### SUMMARY OF THE INVENTION

The present invention provides a method and system for creating or authenticating a session key without server intervention by distributing a public key to home network devices.

In accordance with an aspect of the present invention, a device authentication method includes maintaining a public key list that includes an identifier (ID) and public key information corresponding to the ID of home network devices; receiving an access of a joining device and requesting to the joining device an ID and information relating to a public key of the joining device; receiving the ID and the public key information from the joining device, updating the public key list by adding the received ID and public key information, storing and maintaining the updated public key list; transmitting the updated public key list to the joining device; and transmitting the ID and the public key information of the joining device to the home network devices. The joining device is a new device that joins a home network.

In accordance with another aspect of the present invention, a device authentication method includes maintaining a public key list that includes an ID and public key information corresponding to the ID of home network devices; receiving a request to delete an ID and corresponding public key information of a leaving device; requesting the home network devices to delete the ID and the public key information of the leaving device; and updating the public key list by deleting the ID and the public key information of the leaving device from the public key list. The leaving device is a device that leaves a home network.

In accordance with still another aspect of the present invention, a device authentication system includes a database for storing and maintaining a public key list that includes an ID and corresponding public key information of a device; a general communication section for requesting and receiving the ID and the corresponding public key information of the device; a location limited channel (LLC) communication section for requesting an ID and corresponding public key information of a joining device and transmitting the public key list over a location limited channel; a retrieval section for retrieving the ID and the corresponding public key information of the device from the public key list; and an update section for receiving from the joining device the ID and the public key information of the joining device and updating the public key list.

### BRIEF DESCRIPTION OF THE DRAWINGS

The above and/or other aspects of the invention will become apparent and more readily appreciated from the following description of exemplary embodiments, taken in conjunction with the accompanying drawing figures of which:

FIG. 1 is a flowchart explaining how to register a joining device to a home network according to an exemplary embodiment of the present invention;

FIG. 2 illustrates an updating of a public key list by adding an ID and public key information of a joining device to the public key list according to an exemplary embodiment of the present invention;

FIG. 3 illustrates transmission of the updated public key list to a home network device according to an exemplary embodiment of the present invention;

FIG. 4 is a flowchart explaining how to delete a leaving device from the public key list according to an exemplary embodiment of the present invention;

FIG. 5 illustrates deletion of an ID and public key information of a leaving device from the public key list according to an exemplary embodiment of the present invention; and

FIG. 6 is a block diagram of a home network authentication system according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

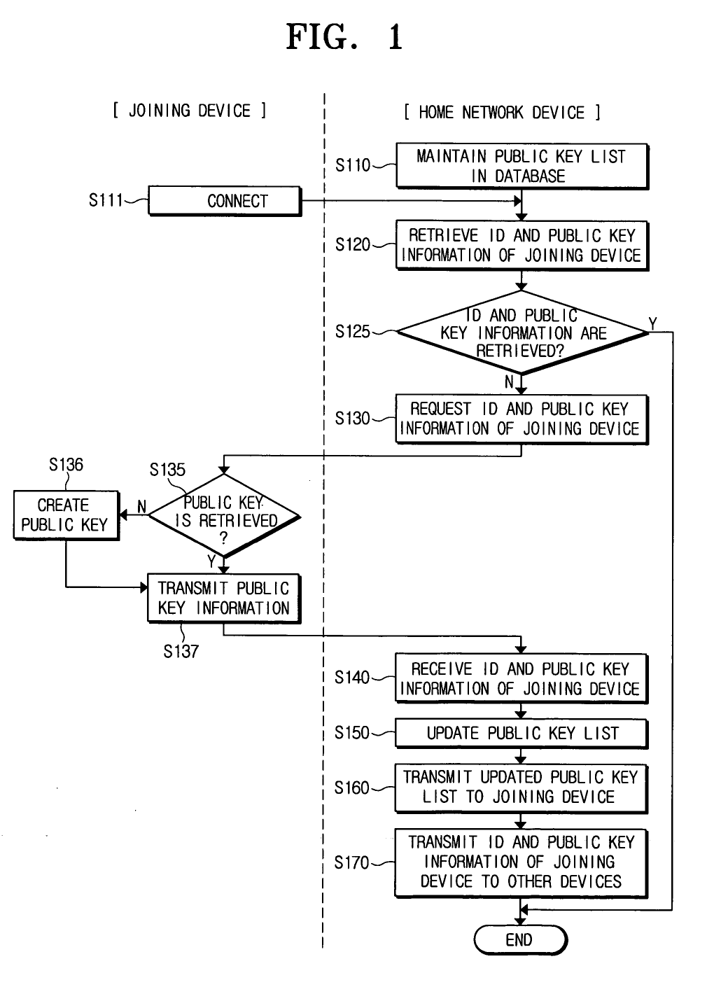

Referring to FIG. 1, a home network device stores and maintains a public key list including IDs and public key information corresponding to the IDs of home network devices (S110). The home network devices each have their own ID and public key information corresponding to the ID. The public key list enumerates the IDs and the public key information of the home network devices. The home network devices, which store and maintain the public key list, can learn based on the public key list whether a device is registered to a home network when the device is connected to another device. The home network device is one of devices registered to the home network. A home network device has its own ID and public key, and holds a public key list for authenticating the home network devices.

When a joining device requests an initial access to the home network (S111), the home network device attempts to retrieve an ID and public key information of the joining device from its public key list (S120). Since the joining device is a new device that is brought in by a user but not yet registered to the home network, the public key list has no ID and public key information of the joining device (S125). Therefore, the home network device can determine that the joining device is to be registered to the home network.

Next, the home network device requests the joining device to provide its ID and public key information (S130). The home network device retrieves an ID and public key information of a connected device based on the public key list. Since there is no information relating to the joining device in the public key list, the home network device needs to record the ID and the public key information of the joining device in its public key list.

Upon receiving the request to provide the ID and the public key information from the home network device, the joining device checks whether its public key is embedded therein (S135). If the public key is embedded in the joining device at a manufacturing phase, the joining device already has its own public key. If the public key is not created at the manufacturing phase, the joining device does not have the public key and operates to create its public key (S136).

The joining device transmits its ID and public key information to the home network device (S137), and the home network device receives the ID and the public key information of the joining device (S140).

The home network device updates and stores its public key list by adding the received ID and public key information of the joining device to the public key list (S150). The updated public key list enables the home network device to retrieve and verify the ID and the public key information of the joining device when the joining device requests a new access to the home network.

The home network device transmits the updated public key list to the joining device (S160). The home network device also broadcasts the ID and the public key information of the joining device to other home network devices over an authentication channel (S170) in order to facilitate the authentication of the joining device such that devices registered to the home network update and store their public key lists. The joining device receives from the home network device and stores the updated public key list, which is to aid the authentication for all of the home network devices.

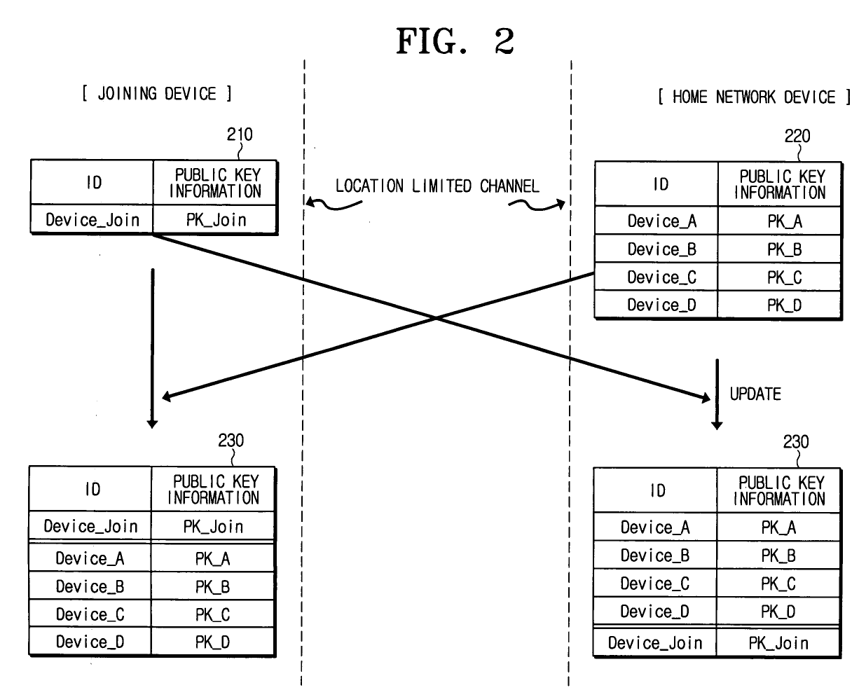

Referring now to FIG. 2, a home network device stores a public key list 220 recording IDs and public key information corresponding to the IDs of home network devices. Since shown in FIG. 2, the public key list can be presented as a table. As the home network devices can be authenticated in reference to the table of the IDs and the public key information, complicated public key operations for the public key verification are not required.

The joining device has its ID (e.g., Device_Join) and public key information (e.g., PK_Join) 210 for registration to the home network. The joining device requests access to the home network device. The home network device retrieves the ID and the public key information 210 of the joining device to confirm whether the joining device requesting the access is a new device in the home network. Since the ID and the public key information 210 of the joining device are not recorded in the public key list 220 of the home network device, the joining device provides its ID and public key information 210 to the home network device. The ID and public key information 210 is transmitted on a location limited channel.

The home network device receives the ID and the public key information 210 of the joining device and updates its public key list 220. Prior to updating, the public key list 220 does not include the ID and the public key information of the joining device and thus is unavailable for the authentication of the joining device. In contrast, the updated public key list 230, which includes the ID and the public key information of the joining device, can be used for the home network device to authenticate the joining device.

The home network device transmits the updated public key list 230 to the joining device so that the joining device can authenticate the home network device. The updated public key list 230 with the ID and the public key information of the joining device includes IDs and public key information of all of the home network devices that use the public key as well. Hence, the joining device can authenticate all of the home network devices that use the public keys based on the public key list 230.

The location limited channel has a limited transmission range. While the smooth communication can be performed within the limited range of the channel, the communication is disabled outside the limited range. Accordingly, it is difficult to learn contents of the communication on the limited location channel, from outside of the channel. In this sense, the location limited channel is well suited for communications among the devices within a restricted area in view of the property of the home network. Furthermore, the location limited channel itself provides the authentication effect and thus is suitable for a setup of the home network.

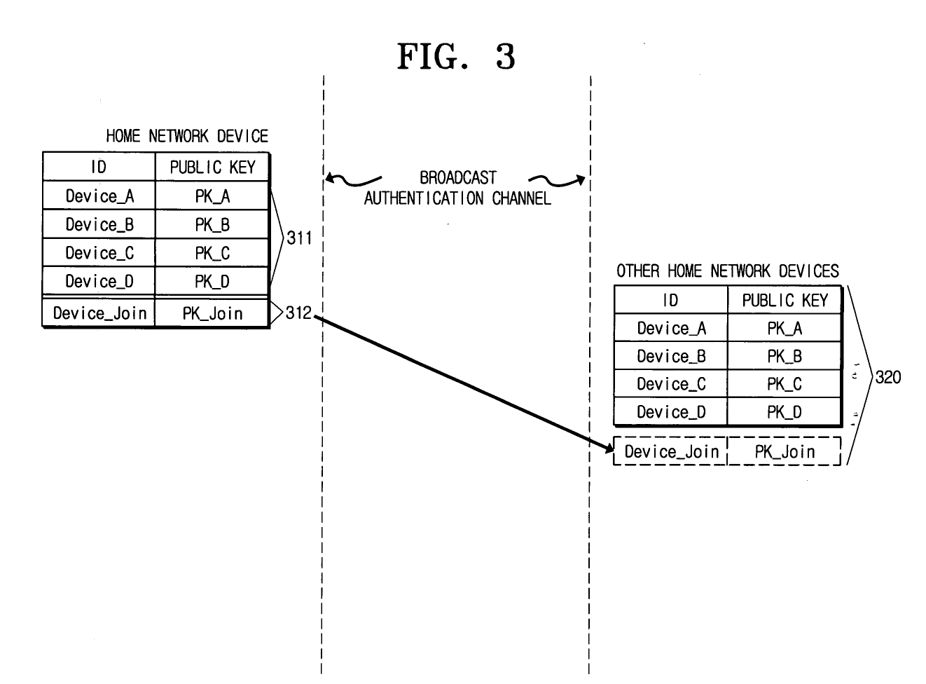

In FIG. 3, upon updating the public key list by adding the ID and the public key information of the joining device, the home network device broadcasts the ID and the public key information of the joining device to all of the other home network devices over the authentication channel. The other home network devices, which maintain a public key list 311, receive and add only the ID and the public information 312 of the joining device to its public key list 311. In this manner, the home network devices can maintain the updated public key list 320 and authenticate the joining device by retrieving the public key information of the joining device.

The joining device is registered to the home network by connecting to one of the home network devices, rather than by accessing a specific server of the home network and registering its ID and public key information. The home network device connected to the joining device temporarily functions as a home network server. Any home network device can register the ID and the public key information of the joining device and update the public key list, which is capable of retrieving the public key list and registering the ID and the public key information.

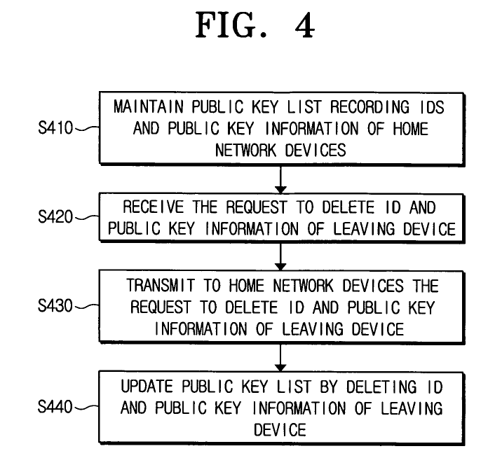

Referring to FIG. 4, a home network device, which is one of devices registered to the home network, maintains a public key list including IDs and public keys corresponding to the IDs of other home network devices (S410). As mentioned above, it is possible to retrieve from the public key list and compare an ID and public key information of a device requesting authentication. The public key list arranges the IDs and the public key information corresponding to the IDs of all of the devices that use the public keys registered to the home network, in the form of a table. The home network devices retrieve from the public key list an ID and public key information of a device that attempts to access, and authenticate the accessed device only when its ID and the public key information are present in the public key list.

The home network device receives a request to delete an ID and public key information of a device leaving the home network (S420). A user selects one of the home network devices registered to the home network, rather than selecting a certain server, and requests to delete the ID and the public key information of the leaving device. The user transmits the ID and the public key information of the leaving device over the location limited channel. As previously mentioned, the location limited channel having the limited transmission range, enables the user to keep the home network device requesting to delete the ID and the public key information of the leaving device within a range of view. By means of the location limited channel, the user directly checks and inputs the ID and the public key information of the leaving device to the home network device and thus prevents the leakage of the ID and the public key information of the leaving device. As a result, the security of the home network can be attained.

The home network device requests the other home network devices to delete the ID and the public key information of the leaving device (S430). The deletion request is broadcast to the other home network devices over the authentication channel. The other home network devices receiving the deletion request, delete the ID and the public key information of the leaving device from their public key lists and update the public key lists.

The deletion of the ID and the public key information of the leaving device is to prevent the leaving device from accessing the home network and obtaining the information. In the event that the ID and the public key information of the leaving device are left behind and the leaving device requests the access to the home network device after the departure, the home network device is liable to misinterpret the leaving device as a device registered to the home network because the ID and the public key information of the leaving device are found in the public key list. In this case, the leaving device may illegally join the home network and incur serious risks.

The home network device updates its public key list by deleting the ID and the public key information of the leaving device from its public key list (S440) and the updated public key list is stored and maintained.

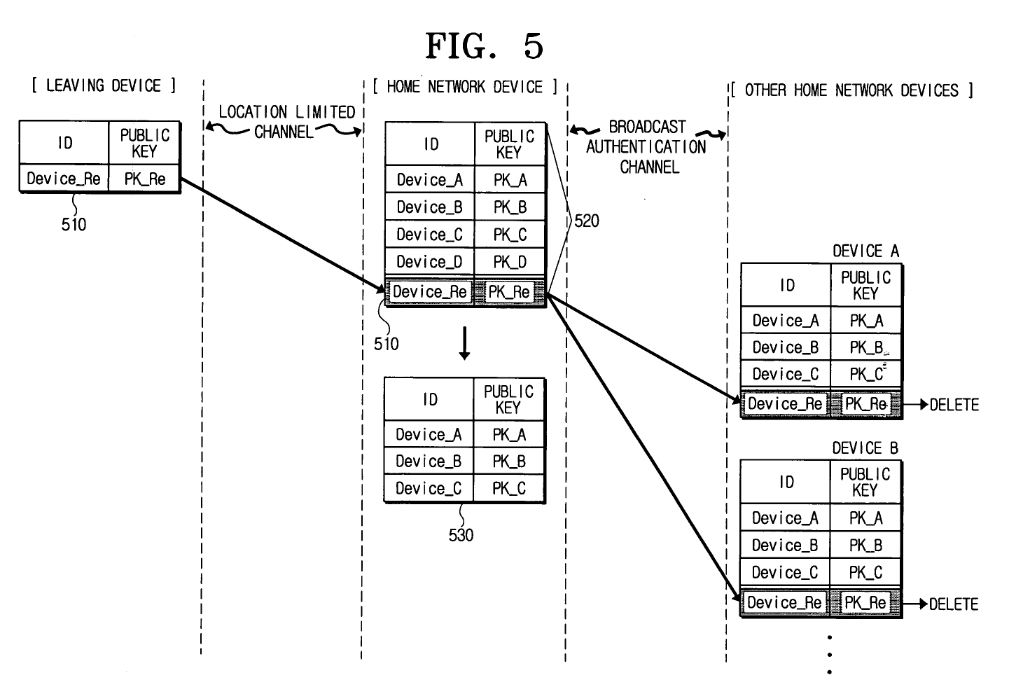

Referring now to FIG. 5, let the ID and the public key information 510 of the leaving device be Device_RE and PK_Re 510, respectively. The user requests the home network device delete the ID and the public key information 510 of the leaving device from the public key list 520. The home network device receives the deletion request and requests the other home network devices to delete the ID and the public key information 510 from their public key lists. Upon receiving the deletion request, the other home network devices delete the ID and the public key information 510 of the leaving device from their public key lists. Likewise, the home network device updates the public key list by deleting the ID and the public key information 510 of the leaving device, and stores the updated public key list 530.

Similar to the joining of a device, the leaving of a device does not access a server. Instead, the deletion of the ID and the public key information of the leaving device from the public key list is carried out by connecting to one of the home network devices.

If the leaving device requests the access, the home network devices can promptly learn whether the leaving device has left the home network from the updated public key list. A leaving device is registered to a certificate revocation list (CRL) held in the home network. Hence, the leaving of a device can be more accurately determined using the CRL.

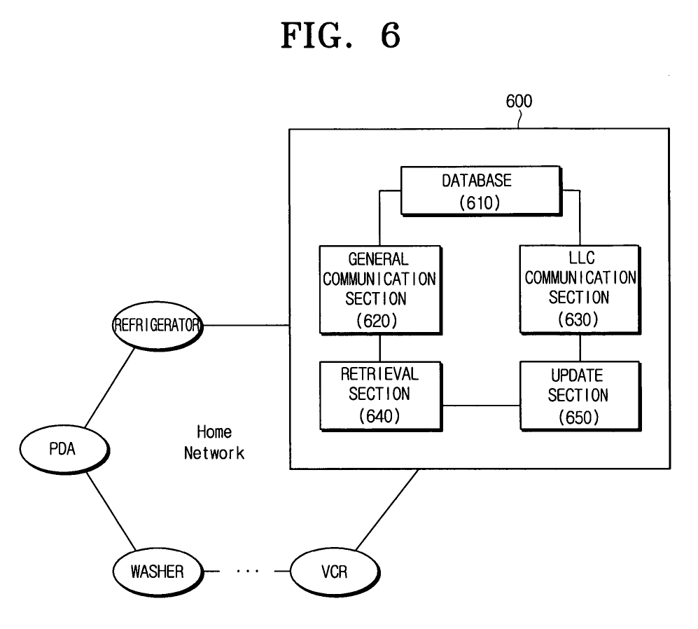

As illustrated in FIG. 6, a home network authentication system 600 includes a database 610, a general communication section 620, a location limited channel (LLC) communication section 630, a retrieval section 640, and an update section 650. The database 610 stores and maintains a public key list including an ID and its corresponding public key of a home network device. The general communication section 620 requests and receives the ID and the corresponding public key information of the home network device. The LLC communication section 630 requests an ID and corresponding public key information of a joining device and transmits the public key list on the location limited channel. The retrieval section 640 retrieves the ID and the corresponding public key information of the home network device from the public key list. The update section 650 updates the public key list by receiving the ID and the public key information from the joining device.

The database 610 stores and provides the public key list so that the retrieval section 640 can retrieve the public key list. The retrieval section 640 retrieves an ID and public key information of a device requesting the access, from the public key list stored in the database 610. The general communication section 620 receives an access request from the device and requests the retrieval section 640 to retrieve the ID and the public key information of the device in the database 610. When the public key list includes the ID and the public key information of the device requesting the access, the retrieval section 640 informs the general communication section 620 of the retrieval. The general communication section 620 informs the device that its ID and public key information are verified.

If the device requesting the access is a joining device not enumerated in the public key list, the joining device requests access to the LLC communication section 630 that is responsible for the communication on the location limited channel. The LLC communication section 630 receives the access request of the joining device but the retrieval section 640 cannot find the ID and the public key information of the joining device in the public key list stored in the database 610. The general communication section 620 requests the joining device to provide its ID and public key information. When the ID and the public key information of the joining device are received on the general communication section 620, the update section 650 updates the public key list by adding the ID and the public key information of the joining device and stores the updated list in the database 610.

In case that a device leaves the home network, the general communication section 620, which receives from a user a request to delete an ID and public key information of the leaving device, requests home network devices to delete the ID and the public key information of the leaving device. The general communication section 620 broadcasts the deletion request to the home network devices over the authentication channel. After the broadcast of the deletion request, the retrieval section 640 retrieves the ID and the public key information of the leaving device from the public key list stored in the database 610. The update section 650 updates the public key list by deleting the retrieved ID and public key information of the leaving device from the public key list, and stores the updated list in the database 610.

In light of the foregoing as set forth above, the public key information of devices can be authenticated by means of the public key list without having to use the encrypted certificates. Since the ID and the corresponding public key information of the devices are verified from the public key list, the home network devices can be authenticated without complicated operations for the public key verification. As result, issuing certificates for the PKI is not required and thus the cost for the certificate issue can be saved. Even a device incapable of performing the public key operations due to its low resources, can easily join the home network device authentication system using the public key list. Therefore, the home network can be established more conveniently.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A device authentication method comprising:
maintaining a public key list that includes identifiers (IDs) and public key information corresponding to the IDs of home network devices of a home network;
receiving a request to access the home network from a joining device;
requesting that the joining device provide an ID and information relating to a public key of the joining device;
receiving the ID and the public key information from the joining device, updating the public key list by adding the received ID and public key information, and storing the updated public key list;
transmitting the updated public key list to the joining device; and
transmitting the ID and the public key information of the joining device to the home network devices,
wherein the joining device is a device that is not previously registered to the home network.

2. The device authentication method of claim 1, wherein the request to access the home network is received from the joining device and the public key list before updating is transmitted to the joining device over a location limited channel.

3. The device authentication method of claim 1, wherein the public key information received from the joining device corresponds to the ID of the joining device, and
the public key is provided to the joining device at a manufacturing phase of the joining device, or created by the joining device in response to the requesting of the public key information.

4. The device authentication method of claim 1, wherein the ID and the public key information of the joining device are broadcast to the home network device over an authentication channel.

5. A device authentication method comprising:
maintaining a public key list that includes an identifier (ID) and public key information corresponding to the ID of home network devices of the home network;
receiving a request to delete an ID and corresponding public key information of a leaving device;
requesting the home network devices to delete the ID and the public key information of the leaving device; and
updating the public key list by deleting the ID and the public key information of the leaving device from the public key list,
wherein the leaving device is a device that leaves the home network.

6. The device authentication method of claim 5, wherein the request to delete the ID and the corresponding public key information of the leaving device is broadcast over an authentication channel.

7. The device authentication method of claim 5, wherein the request to delete the ID and the corresponding public key information of the leaving device is broadcast over a location limited channel.

8. A device authentication system comprising:
a database which stores a public key list that includes an identifier (ID) and corresponding public key information of a device of a home network;
a general communication section which requests and receives the ID and the corresponding public key information of the device;
a location limited channel communication section which requests an ID and corresponding public key information of a joining device and transmits the public key list over a location limited channel, wherein the joining device is a device that is not previously registered to the home network;
a retrieval section which retrieves the ID and the corresponding public key information of the device from the public key list; and
an update section which receives from the joining device the ID and the public key information of the joining device and updates the public key list to include the ID and the public key information of the joining device.

9. The device authentication system of claim 8, wherein the update section receives from a leaving device an ID and public key information of the leaving device and updates the public key list by deleting the ID and the public key information of the leaving device from the public key list, wherein the leaving device is a device that leaves the home network.
